(19) United States
(12) Patent Application Publication
(10) Pub. No.: US 2012/0048095 A1
(43) Pub. Date: Mar. 1, 2012

(54) FAN-DRUM

(76) Inventor: Ying-Jen Chen, Taoyuan City (TW)

(21) Appl. No.: 12/870,803

(22) Filed: Aug. 28, 2010

(51) Int. Cl. G10D 13/02

(52) U.S. Cl. 84/411 R

(57) ABSTRACT

A fan-drum includes a drum frame having two clamping frame members fastened together, an eyelet located on one end of one clamping frame member and a handle located on the end of one clamping frame member, a drum head fixedly set in between the two clamping frame members, and beaters suspending from the eyelet of the drum frame at two opposite sides relative to the drum head, each beater having a shank, a hook located on one end of the shank and pivotally coupled to the eyelet and a ball-head located on the other end of the shank for beating one clamping frame member or the drum head to produce sound.

### BACKGROUND OF THE INVENTION

1. Field of the Invention

The present invention relates to toy drums and more particularly, to a fan-drum, which is made in the form of a fan and can be oscillated to produce sound rhythmically for entertainment or commercial purposes.

2. Description of the Related Art

When hot, people may use an air-conditioner or electric fan to cool down the indoor space temperature. Further, a hand fan may be used personally to cause currents of air for cooling. Hand fans are also commonly used as small gifts for commercial promotion. A simple hand fan is known comprising a fan surface and a handle holding the fan surface. When oscillating the handle, the fan surface is moved to cause currents of air. This design of hand fan is monotonous and not attractive. After the use in an activity, people may directly throw the hand fan away, causing waste.

### SUMMARY OF THE INVENTION

The present invention has been accomplished under the circumstances in view. It is the main object of the present invention to provide a fan-drum, which is made in the form of a fan and can be oscillated to produce sound rhythmically, enjoying and attracting other people.

To achieve this and other objects of the present invention, a fan-drum comprises a drum frame having two clamping frame members fastened together, an eyelet located on one end of one clamping frame member and a handle located on the end of one clamping frame member, a drum head fixedly set in between the two clamping frame members, and beaters suspending from the eyelet of the drum frame at two opposite sides relative to the drum head. Each beater comprises a shank, a hook located on one end of the shank and pivotally coupled to the eyelet and a ball-head located on the other end of the shank for beating one clamping frame member or the drum head to produce sound.

### BRIEF DESCRIPTION OF THE DRAWINGS

FIG. 1 is an elevational view of a fan-drum in accordance with a first embodiment of the present invention.

FIG. 2 is an exploded view of the fan-drum in accordance with the first embodiment of the present invention.

FIG. 3 is a schematic drawing of the first embodiment of the present invention, illustrating the relationship between the eyelet and the hook of the beater.

FIG. 4 is a schematic drawing of the first embodiment of the present invention, illustrating an operation status of the fan-drum.

FIG. 5 is an elevational view of a fan-drum in accordance with a second embodiment of the present invention.

### DETAILED DESCRIPTION OF THE PREFERRED EMBODIMENT

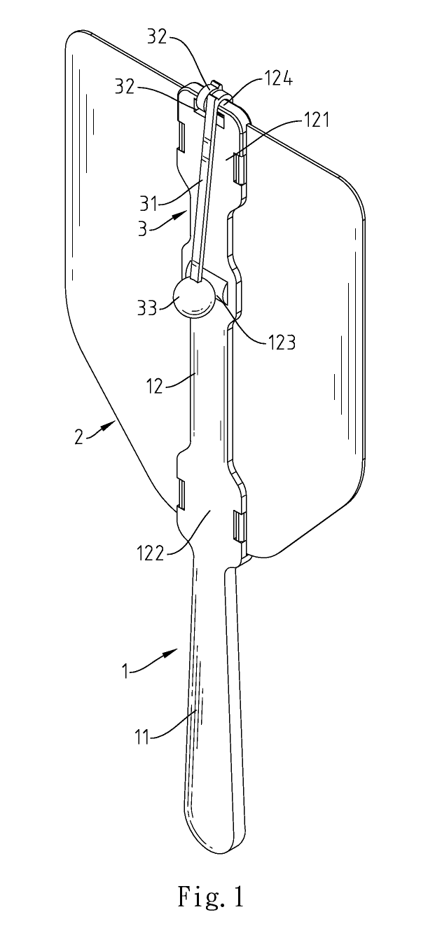

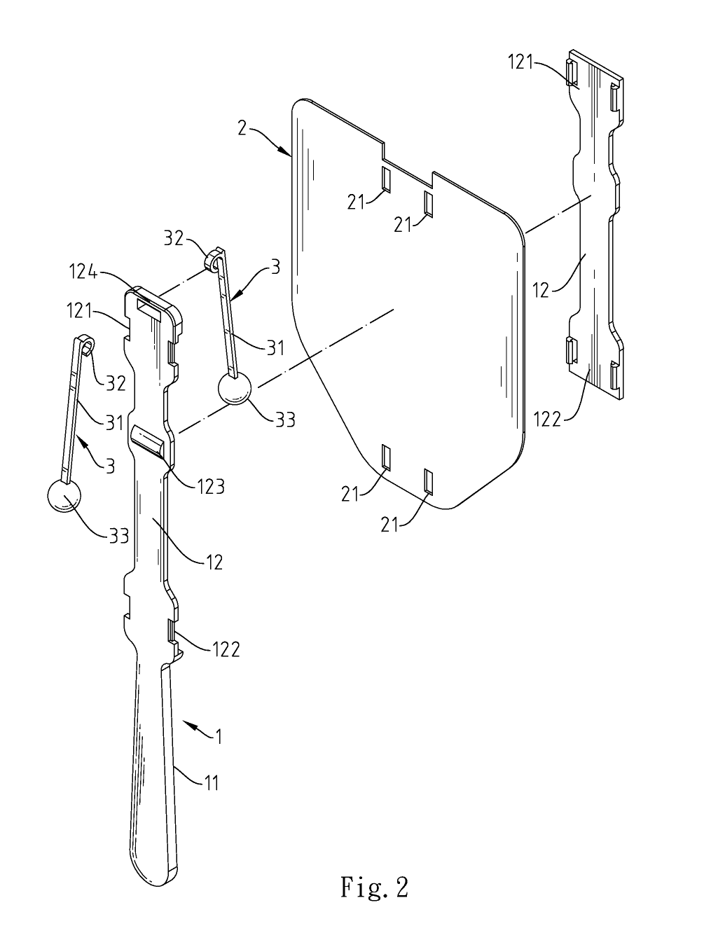

Referring to FIGS. 1 and 2, a fan-drum in accordance with the present invention is shown comprising a drum frame 1, a drum head 2 and a plurality of beaters 3.

The drum frame 1 comprises two clamping frame members 12 that are fastened together by an upper fastening members 121 and a lower fastening members 122 and that have at least one transverse rib 123, an eyelet 124 located on one end of one (or each) clamping frame member 12 and a handle 11 axially extended from the other end of the same (or each) clamping frame member 12.

The drum head 2 has a plurality of mounting through holes 21 for the passing of the upper fastening members 121 and lower fastening members 122 of the clamping frame members 12. Further, the drum head 2 can carry a design or words.

Each beater 3 comprises a shank 31, a hook 32 located on one end of the shank 31 and a ball-head 33 located on the other end of the shank 31. Further, the hook 32 and the shank 31 define an opening 321.

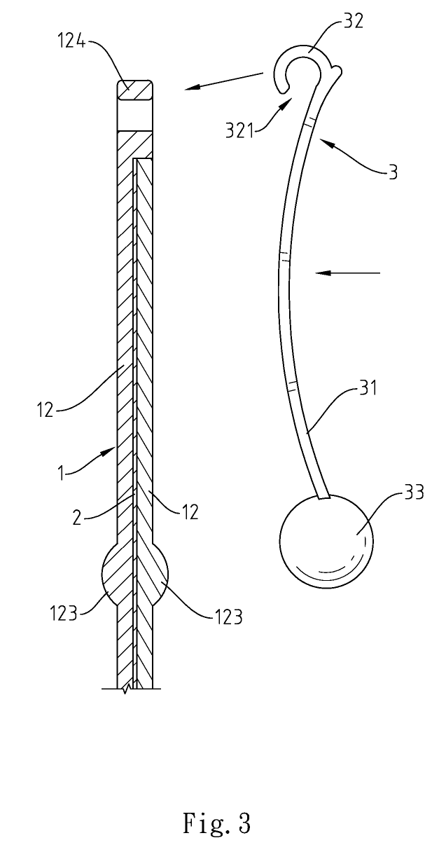

Referring to FIG. 3 and FIG. 1 again, the drum head 2 is clamped by the clamping frame members 12. The upper fastening members 121 and lower fastening members 122 of the clamping frame members 12 are inserted through the mounting through holes 21 of the drum head 2 and fastened together. By means of the opening 321 of each beater 3, the hook 32 of each beater 3 is hooked in the eyelet 124 of the drum frame 1. Further, the beaters 3 are elastically deformable. During installation, the shank 31 is slightly elastically deformed for allowing the hook 32 to be hooked in the eyelet 124 of the drum frame 1. After the hook 32 having been hooked in the eyelet 124 of the drum frame 1, release the hand from the beater 3, and the beater 3 immediately returns to its former shape subject to the effect of its elastically deformable material property, and therefore the hook 32 is pivotally secured to the drum frame 1 and will not fall from the eyelet 124. At this time, the beaters 3 are suspended from the eyelet 124 to keep the respective ball-heads 33 in contact the transverse ribs 123. Further, multiple beaters 3 can be arranged in parallel on each of two opposite sides relative to the drum head 2.

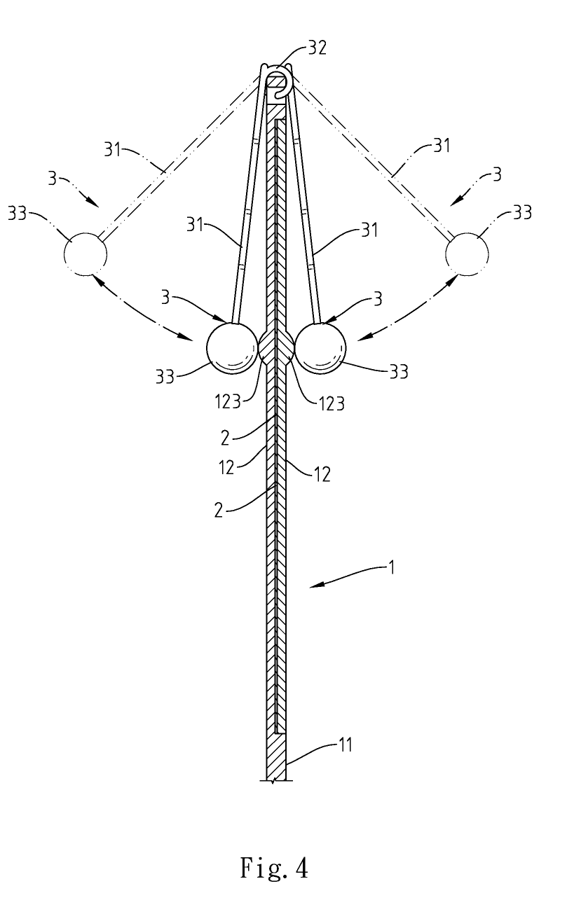

Referring to FIG. 4, when the user is holding and swinging the handle 11, the drum head 2 is oscillated, and the beaters 3 are moved back and forth relative to the drum head 2, and therefore the ball-heads 33 of the beaters 3 are moved to beat the transverse ribs 123, producing sound rhythmically.

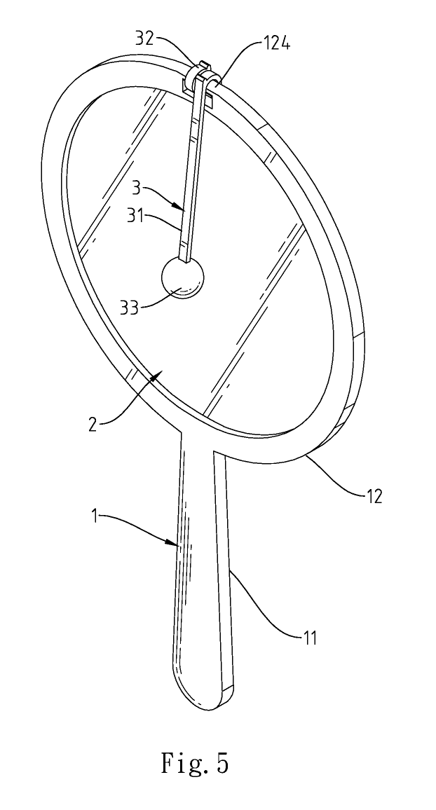

Referring to FIG. 5, as an alternate form of the present invention, the clamping frame members 12 are shaped like a ring and adapted to hold and surround the periphery of the drum head 2. When the user is holding and swinging the handle 11, the drum head 2 is oscillated, and the beaters 3 are alternatively moved back and forth relative to the drum head 2, and therefore the ball-heads 33 of the beaters 3 are moved to beat the center area of the drum head 2, producing sound rhythmically.

As stated above, the invention provides a fan-drum, which comprises a drum frame 1, a drum head 2 head in place by the drum frame 1, and beaters 3 suspending from the drum frame 1 and adapted for beating the drum frame 1 or drum head 2 to produce sound when the user oscillates the drum frame 1. Further, the drum head 2 can carry a design of words.

Although particular embodiments of the invention have been described in detail for purposes of illustration, various modifications and enhancements may be made without departing from the spirit and scope of the invention.

What is claimed is:

1. A fan-drum, comprising:
a drum frame, said drum frame comprising two clamping frame members fastened together, an eyelet located on one end of at least one said clamping frame member and a handle located on an opposite end of at least one said clamping frame member;
a drum head fixedly set in between said two clamping frame members; and
a plurality of beaters suspending from said eyelet of said drum frame at two opposite sides relative to said drum head, each said beater comprising a shank, a hook located on one end of said shank and pivotally coupled to said eyelet and a ball-head located on an opposite end of said shank.

2. The fan-drum as claimed in claim 1, wherein said two clamping frame members each have an upper fastening member and a lower fastening member, the upper fastening member and lower fastening member of one said clamping frame member being fastenable to the upper fastening member and lower fastening member of the other said clamping frame member; said drum head has a plurality of mounting through holes for the passing of the upper fastening members and lower fastening members of said clamping frame members.

3. The fan-drum as claimed in claim 1, wherein said beaters are so arranged that the ball-head of each said beater is forced to beat one said clamping frame member when said drum frame is oscillated by a user.

4. The fan-drum as claimed in claim 1, wherein each said clamping frame member has a rib for beating by the ball-head of one said beater.

5. The fan-drum as claimed in claim 1, wherein each said beater has an opening defined between the shank and hook thereof through which the hook is hooked in said eyelet.

6. The fan-drum as claimed in claim 1, wherein a plurality of said beaters are arranged in parallel on each of two opposite sides relative to said drum head.

7. The fan-drum as claimed in claim 1, wherein said beaters are so arranged that the ball-head of each said beater is forced to beat said drum head when said clamping drum frame is oscillated by a user.
